(19) United States
(12) Patent Application Publication
(10) Pub. No.: US 2010/0180483 A1
(43) Pub. Date: Jul. 22, 2010

(54) ADHESIVE FRAME FOR A PHOTOGRAPH OR PICTURE AND METHOD OF MAKING THE SAME

(76) Inventor: Maurice Mindel, London (GB)

Correspondence Address: SUGHRUE MION, PLLC, 2100 PENNSYLVANIA AVENUE, N.W., SUITE 800, WASHINGTON, DC, 20037, US

(21) Appl. No.: 12/524,650

(22) PCT Filed: Jan. 22, 2008
(86) PCT No.: PCT/GB08/00224

§ 371 Date: Feb. 23, 2010

(30) Foreign Application Priority Data
Jan. 25, 2007 (GB) 0701394.9

(51) Int. Cl. A47G 1/17; B32B 38/04

(52) U.S. Cl. 40/760; 156/250

(57) ABSTRACT

An adhesive frame for a photograph or picture, the frame comprising: a layer of felt; a coating of a permanent adhesive on one side of the layer of felt; a coating of a removable adhesive on the other side of the layer of felt for removably adhering the adhesive frame to a wall; and a frame attached to the felt by the permanent adhesive creating inner and outer borders of the adhesive frame.

### FIELD OF INVENTION

The present invention relates to an adhesive frame for a photograph or picture and a method of making the same. Embodiments of the present invention provide re-usable frames which can be reliably mounted and re-mounted to a non-smooth surface without any additional components and without damaging the surface or the frame.

### BACKGROUND

A normal photographic frame is a manufactured product that frames a photograph or other picture in order to enhance its appearance. It does this by creating a border all around which is raised above the picture. Existing frames have a rear attachment to allow for them to be hung from a pin in the wall or for the attachment of a device on the rear that allows the frame to stand at an angle on a flat horizontal surface.

Accordingly, prior art arrangements are known in which a photograph can be displayed on a vertical surface using a nail or other damaging object to be inserted into the vertical surface from which the photo frame can be hung.

It is also known to provide wall frames which have to be attached to a wall by hooks or self adhesive foam pads which are external to the frame and not an integrated part thereof.

Another known alternative is a frame which is magnetic. However, the use of this frame is restricted to metal surfaces.

It is also known to provide a frame with an adhesive on a rear side thereof for adhering the frame to a surface.

The present applicant has found that none of the aforementioned arrangements are suitable for providing a re-usable frame which can be reliably mounted and re-mounted to a non-smooth surface without any additional components and without damaging the surface or the frame.

Accordingly, it is an aim of embodiments of the present invention to solve the aforementioned problem.

### SUMMARY OF THE INVENTION

According to a first aspect of the present invention there is provided an adhesive frame for a photograph or picture, the frame comprising: a layer of felt; a coating of a permanent adhesive on one side of the layer of felt; a coating of a removable adhesive on the other side of the layer of felt for removably adhering the adhesive frame to a wall; and a frame attached to the felt by the permanent adhesive creating inner and outer borders of the adhesive frame.

According to a second aspect of the present invention there is provided a method of manufacturing an adhesive frame according to any preceding claim, the method comprising: coating a layer of felt with a permanent adhesive on one side thereof and a removable adhesive on the other side thereof; adhering a layer of plastic to the felt via the permanent adhesive to form a sandwich structure; punching a hole through the resultant sandwich structure to create inner and outer borders of the adhesive frame.

By removable adhesive we do not mean that the adhesive can necessarily be removed from the felt layer. Rather we mean that the adhesive provides a removable bond with a surface to which it is adhered such that the adhesive frame can be adhered to a surface, removed, and then re-adhered.

The layer of felt provides a yielding effect for adherence of a frame to a textured surface. In addition, the present applicant has found that a layer of felt coated with a removable adhesive allows adhesion and removal of the frame from a wall several times without leaving a residue on the wall, without losing too much adhesion, and without damaging the felt/adhesive layer. In contrast, thin layers of materials such as foam have been found to be weak in strength such that if the frame is adhered and removed several times the thin layer of foam tears. Alternatively, other possible materials have been found to be too rigid such that they do not provide sufficient yielding effect for adherence of a frame to a textured surface.

Thus, one inventive feature of the present application lies in the finding that a layer of felt coated with a removable adhesive is ideal for mounting photograph or picture frames onto a textured surface such that they can be removed, replaced or rearranged several times without damaging or altering the surface of the wall and at the same time not damaging the adhesive/felt structure. Accordingly, the adhesive frame of the present invention is reliably adhered to the wall even after several cycles of removing and replacing.

It should be noted that the adhesive properties required for mounting an object to a wall are highly dependent on the nature of the object. For removable adhesion, the mounting materials must be strong enough to support the object to be mounted while being weak enough that the object can be removed and then remounted several times. As such, for any particular type of object, there is a narrow range of adhesive strength. A mounting arrangement must be found which falls within this narrow range for mounting a particular object. In the present case, the applicant has found that a layer of felt coated with a removable adhesive is ideal for mounting photograph and picture frames onto a wall such that they can be removed, replaced or rearranged several times without damaging or altering the surface of the wall and at the same time not damaging the adhesive/felt structure. The particular application of integrating a layer of felt coated with a removable adhesive into a photograph or picture frame is therefore not considered obvious. There are a very large number of ways of adhering various objects in various different fields of art and the provision of a particular adhesive arrangement for a particular use is not an obvious matter.

### DETAILED DESCRIPTION

Embodiments of the present invention are hereinafter referred to as FRAME ANYWHERE.

FRAME ANYWHERE allows for photographs to be displayed on most vertical surfaces without the necessity of piercing the vertical surface or causing any damage to it whatsoever.

FRAME ANYWHERE provides a photo frame that it is backed by a layer of felt with an adhesive coating. FRAME ANYWHERE borders the photograph and attaches by adhesion to most surfaces thereby holding the photograph in place against a vertical wall or other surface. The unique felt/adhesive arrangement allows the photo or picture to be readily stuck to a wall or another object such as a door, a refrigerator, a mirror or cupboard without damaging or altering that surface. The pressure sensitive adhesive property of the felt/adhesive arrangement permits this to take place several times without leaving a residue on the surface such that the adhesive frame can be removed, replaced or re-arranged as required. Furthermore, the felt has sufficient yielding effect to absorb any slight irregularities on the surface to which the frame is attached to allow the frame to be stuck to a wide variety of surfaces without falling off.

An embodiment of the adhesive frame is made by first coating felt with a permanent adhesive on one side of the felt and a removable adhesive on the other. The permanent adhesive side of the felt is then attached to a thin plastic such as polypropylene and the resultant sandwich of plastic attached to adhesive covered felt is then punched out to create the inner and outer borders of the frame. The adhesive felt can also be attached to other materials such as acrylic plastic or leather to create a variety of styles of adhesive frames for pictures and photographs.

The frame will generally have sufficient depth to provide a raised surface to surround the picture or photo, e.g. the frame may have a thickness in the range 1 mm to 1 cm. Frames may be provided for mounting standard sizes of photographs, e.g. to mount photographs of sizes 4×6 inch (10.2×15.24 cm), 5×7 inch (12.7×17.78 cm), 6×8 inch (15.24×20.32 cm), etc., although it will be understood that standard sizes of photograph may vary according to photographic equipment and geographical location.

In accordance with certain preferred embodiments the frame is made of a material and thickness such that it is flexible. For example, according to embodiments the frame can be bent to an angle of 20°, 40° 60° or even 90° or more without breaking. In one embodiment the frame can be completely rolled up. It has been found that flexible frames, in combination with the felt/adhesive mounting, are ideal for adhering, removing, and re-adhering the frame to a surface. The flexibility aids in mounting the frame to a wall using a roll-on, peel-off action.

While this invention has been particularly shown and described with reference to preferred embodiments, it will be understood to those skilled in the art that various changes in form and detail may be made without departing from the scope of the invention as defined by the appendant claims.

1. An adhesive frame for a photograph or picture, the frame comprising:
a layer of felt;
a coating of a permanent adhesive on one side of the layer of felt;
a coating of a removable adhesive on the other side of the layer of felt for removably adhering the adhesive frame to a wall; and
a frame attached to the felt by the permanent adhesive creating inner and outer borders of the adhesive frame.

2. An adhesive frame according to claim 1, wherein the removable adhesive is a pressure sensitive adhesive.

3. An adhesive frame according to claim 1, wherein the frame is made of plastic.

4. An adhesive frame according to claim 3, wherein the plastic is polypropylene.

5. An adhesive frame according to claim 1, wherein the frame has a thickness in the range 1 mm to cm.

6. An adhesive frame according to claim 1, wherein the frame is flexible.

7. A method of manufacturing an adhesive frame according to claim 1, the method comprising:
coating a layer of felt with a permanent adhesive on one side thereof and a removable adhesive on the other side thereof;
adhering a layer of plastic to the felt via the permanent adhesive to form a sandwich structure;
punching a hole through the resultant sandwich structure to create inner and outer borders of the adhesive frame.

8. An adhesive frame according to claim 2, wherein the frame is made of plastic.

9. An adhesive frame according to claim 8, wherein the plastic is polypropylene.
